(19) United States
(12) Patent Application Publication
(10) Pub. No.: US 2008/0315799 A1
(43) Pub. Date: Dec. 25, 2008

(54) Apparatus for Preventing Leakage of Material Inside Bulb for Plasma Lighting System

(76) Inventors: Byoong-Ju Park, Seoul (KR); Dae-Kyung Kim, Seoul (KR)

Correspondence Address: BIRCH STEWART KOLASCH & BIRCH, PO BOX 747, FALLS CHURCH, VA, 22040-0747, US

(21) Appl. No.: 10/585,740

(22) PCT Filed: Mar. 14, 2006
(86) PCT No.: PCT/KR2006/000908

§ 371 Date: Jul. 12, 2006

(51) Int. Cl. H01J 15/04

(52) U.S. Cl. 315/344; 315/326

(57) ABSTRACT

An apparatus for preventing leakage of a material inside a bulb for a plasma lighting system comprises a bulb containing a discharge material therein for emitting light as the discharge material becomes a plasma state by an electric field, and a magnetic field forming portion for preventing the discharge material of a plasma state from being leaked by an external electric field of the bulb by forming a magnetic field at a peripheral portion of the bulb. The discharge material is prevented from being leaked out of the bulb even if the bulb is used for a long time, and thus a lifespan of the bulb is prolonged.

### TECHNICAL FIELD

The present invention relates to a plasma lighting system using electromagnetic wave, and more particularly, to an apparatus for preventing leakage of a material inside a bulb for a plasma lighting system.

### BACKGROUND ART

Generally, a plasma lighting system (PLS) emits light of a high optical amount without an electrode by making a discharge material inside a bulb into a plasma state by electromagnetic wave generated from a magnetron (high frequency oscillator) of a microwave oven and thereby continuously emitting light by a metal compound.

The bulb of the plasma lighting system contains a main discharge material such as a metal, a halogen-based compound, sulfur, or selenium for emitting light by forming plasma, inactive gas such as Ar, Xe, Kr, etc. for forming plasma inside a light emitting portion at the time of an initial luminance, and a discharge catalyst material such as Hg for facilitating lighting by an initial discharge or controlling a light spectrum. Recently, a material including Na, etc. is added into the bulb in order to enhance an optical efficiency.

FIG. 1 is a longitudinal section view showing one example of a plasma lighting system in accordance with the conventional art.

As shown, the conventional plasma lighting system comprises a magnetron 20 mounted in a casing 10 and generating electromagnetic wave, a high voltage generator 30 for supplying alternating current (AC) power to the magnetron 20 by boosting into a high voltage, a wave guide 40 connected to an outlet of the magnetron 20 for transmitting electromagnetic wave generated from the magnetron 20, a resonator 50 connected to an outlet of the wave guide 40 for resonating the electromagnetic wave passing through the wave guide 40, a bulb 60 disposed in the resonator 50 for emitting light by making the discharge material filled therein into plasma by electromagnetic wave, a reflector 70 containing the resonator 50 therein for forwardly reflecting light generated from the bulb 60, a dielectric mirror 80 mounted in the resonator 50 positioned at a rear side of the bulb 60 for passing electromagnetic wave and reflecting light, and a cooling fan 90 disposed at one side of the casing 10 for cooling the magnetron 20 and the high voltage generator 30.

The bulb 60 comprises a light emitting portion 61 having an inner volume and a sphere shape formed of a quartz material, disposed outside the casing 10, and having a discharge material, a discharge catalyst material, etc. therein for emitting light by making the inner materials into plasma; and a supporting portion 62 integrally extending from the light emitting portion 61 and supported in the casing 10.

An unexplained reference numeral 11 denotes an air inlet, 12 denotes an air outlet, 13 denotes an air flow path, M1 denotes a bulb motor for rotating the bulb, and M2 denotes a fan motor for rotating the cooling fan.

An operation of the conventional plasma lighting system will be explained as follows.

When a driving signal is inputted to the high voltage generator 30 by a controller, the high voltage generator 30 boosts alternating current (AC) power thus to supply it to the magnetron 20. Then, the magnetron 20 is oscillated by the high voltage thus to generate electromagnetic wave having a high frequency. The electromagnetic wave is emitted into the resonator 50 through the wave guide 40, and continuously excites the discharge material and the discharge catalyst material contained in the bulb 60 into a plasma state. As the result, light having a specific emission spectrum is generated, and the light is forwardly reflected by the reflector 70 and the dielectric mirror 80 thus to illuminate a space.

However, the conventional plasma lighting system has the following problem. When an additive such as Na is contained in the light emitting portion 61 of the bulb 60 in order to enhance an optical efficiency, the Na is leaked from the light emitting portion 61 of the bulb 60 formed of quartz. Accordingly, an amount of the discharge material inside the light emitting portion 61 of the bulb 60 is decreased. As the result, when the plasma lighting system is used for a long time, an optical efficiency of the bulb 60 is lowered and thus a lifespan of the bulb is shortened.

### DISCLOSURE OF THE INVENTION

Therefore, an object of the present invention is to provide an apparatus for preventing leakage of a material inside a bulb for a plasma lighting system capable of preventing Na contained in the bulb from being leaked.

To achieve these and other advantages and in accordance with the purpose of the present invention, as embodied and broadly described herein, there is provided an apparatus for preventing leakage of a material inside a bulb for a plasma lighting system, comprising: a bulb for containing a discharge material for emitting light as the discharge material therein becomes a plasma state by an electric field; and a magnetic field forming portion for preventing the discharge material of a plasma state from being leaked by an external electric field of the bulb by forming a magnetic field at a peripheral portion of the bulb.

According to another embodiment, there is provided an apparatus for preventing leakage of a material inside a bulb for a plasma lighting system, comprising: a resonator; a bulb received in the resonator and containing a discharge material therein for emitting light as the discharge material becomes a plasma state by an electric field; and a magnetic field forming portion for preventing the discharge material of a plasma state from being leaked by an external electric field of the bulb by forming a magnetic field at a peripheral portion of the bulb.

According to still another embodiment, there is provided an apparatus for preventing leakage of a material inside a bulb for a plasma lighting system, comprising: a magnetron mounted in a casing; a wave guide connected to the magnetron for guiding electromagnetic wave; a resonator connected to the wave guide for resonating electromagnetic wave; a bulb received in the resonator and containing a discharge material therein for emitting light as the discharge material becomes a plasma state by an electric field; and a magnetic field forming portion for preventing the discharge material of a plasma state from being leaked by an external electric field of the bulb by forming a magnetic field at a peripheral portion of the bulb.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal section view showing one example of a plasma lighting system in accordance with the conventional art;

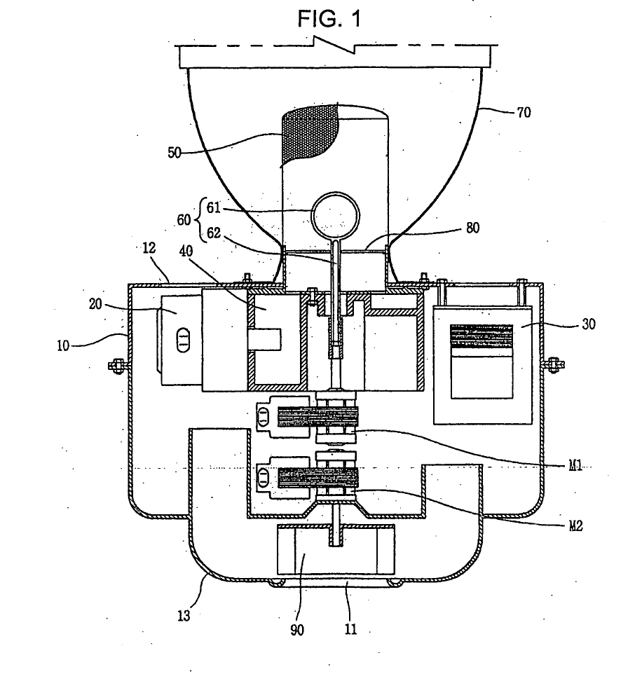

FIG. 2 is a longitudinal section view showing one example of a plasma lighting system according to the present invention; and

FIG. 3 is a schematic view showing a magnetic field formed at a peripheral portion of the bulb of the plasma lighting system according to the present invention.

### MODES FOR CARRYING OUT THE PREFERRED EMBODIMENTS

Reference will now be made in detail to the preferred embodiments of the present invention, examples of which are illustrated in the accompanying drawings.

Hereinafter, an apparatus for preventing leakage of a material inside a bulb for a plasma lighting system according to the present invention will be explained in more detail with reference to one embodiment of the attached drawings.

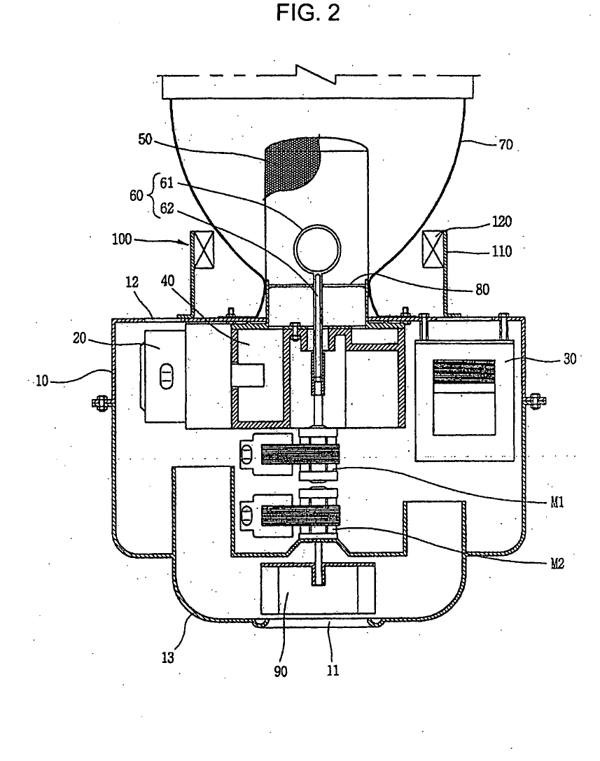

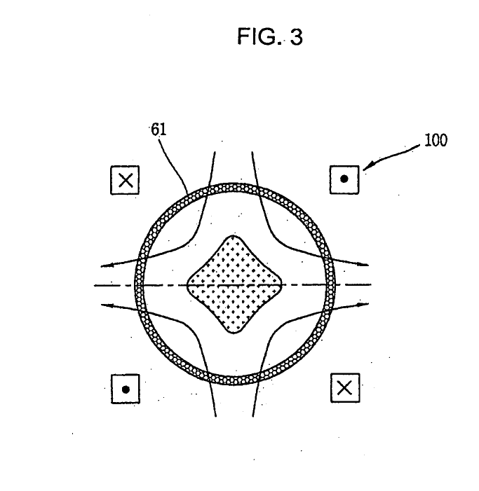

FIG. 2 is a longitudinal section view showing one example of a plasma lighting system according to the present invention, and FIG. 3 is a schematic view showing a magnetic field formed at a peripheral portion of the bulb of the plasma lighting system according to the present invention.

The apparatus for preventing leakage of a material inside a bulb for a plasma lighting system according to the present invention comprises a magnetron 20 mounted in a casing 10 and generating electromagnetic wave, a high voltage generator 30 for supplying alternating current (AC) power to the magnetron 20 by boosting into a high voltage, a wave guide 40 connected to an outlet of the magnetron 20 for transmitting electromagnetic wave generated from the magnetron 20, a resonator 50 connected to an outlet of the wave guide 40 for resonating the electromagnetic wave passing through the wave guide 40, a bulb 60 disposed in the resonator 50 for emitting light by making the discharge material filled therein into plasma by electromagnetic wave, a reflector 70 containing the resonator 50 therein for forwardly reflecting light generated from the bulb 60, a dielectric mirror 80 mounted in the resonator 50 positioned at a rear side of the bulb 60 for passing electromagnetic wave and reflecting light, a cooling fan 90 disposed at one side of the casing 10 for cooling the magnetron 20 and the high voltage generator 30; and a magnetic field forming portion 100 disposed at an outer circumferential surface of the reflector 70 for forming a magnetic field at a peripheral portion of a light emitting portion 61 of the bulb 60.

The bulb 60 comprises a light emitting portion 61 having an inner volume and a sphere shape formed of a quartz material, disposed outside the casing 10, and having a discharge material, a discharge catalyst material, Na, etc. therein for emitting light by making the inner materials into plasma; and a supporting portion 62 integrally extending from the light emitting portion 61 and supported in the casing 10.

As shown in FIG. 3, the magnetic field forming portion 100 is formed to have a wedge shape so that the Na of a plasma state inside the light emitting portion 61 of the bulb 60 can be positioned at the center of the light emitting portion 61 and can be prevented from being leaked out by an external electric field of the of the bulb.

The magnetic field forming portion 100 is implemented as an electromagnet or a permanent magnet. The magnet field forming portion 100 can be installed to be in contact with an outer circumferential surface of the light emitting portion 61 of the bulb 60 or can be installed at a peripheral portion of the light emitting portion 61 of the bulb 60. Also, the magnet field forming portion 100 can be installed to be in contact with an outer circumferential surface of the reflector 70 or can be installed at a peripheral portion of the outer circumferential surface of the reflector 70.

Preferably, the magnetic field forming portion 100 is implemented as an electromagnet so as to be operated only during an operation of the plasma lighting system. For instance, when the magnetic field forming portion 100 is implemented as an electromagnet, the electromagnet 120 is mounted in a housing 110 and the housing 110 is fixed to the casing 10.

When the magnetic field forming portion 100 is implemented as a permanent magnet (not shown), the permanent magnet can be fixed to an outer circumferential surface of the casing 10.

An unexplained reference numeral 11 denotes an air inlet, 12 denotes an air outlet, 13 denotes an air flow path, M1 denotes a bulb motor for rotating the bulb, and M2 denotes a fan motor for rotating the cooling fan.

An operation of the apparatus for preventing leakage of a material inside a bulb for a plasma lighting system according to the present invention will be explained as follows.

When power is supplied to the magnetron 20 from a power supply unit (not shown) by a controller, the magnetron 20 generates electromagnetic wave having a high frequency. The generated electromagnetic wave is introduced into the resonator 50 through the wave guide 40 thus to be resonated. In this process, the discharge material inside the light emitting portion 61 of the bulb 60 is discharged thus to become a plasma state and to emit light of a high optical amount. The light is forwardly reflected by the reflector 70 and the dielectric mirror 80 thus to illuminate a space.

Herein, an additive such as Na contained in the light emitting portion 61 of the bulb 60 tends to be leaked out of the light emitting portion 61 of the bulb 60 by an external electric field of the bulb 60. However, in the present invention, the electromagnet 120, the magnetic field forming portion 100 is installed at an outer circumferential surface of the reflector 70, or at a peripheral portion of the reflector 70, or at the casing 10. The electromagnet 120 serves as a kind of passivation layer thus to prevent the additive such as Na from being leaked out by an external electric field of the bulb 60. For instance, as shown in FIG. 3, a magnetic field is formed as a wedge shape at a peripheral portion of the light emitting portion 61 of the bulb 60 by a magnetic force of the electromagnet 120 or a magnetic force of a permanent magnet (not shown). The magnetic field distributed as a wedge shape prevents the discharge material contained in the bulb 60 from approaching to a wall surface of the bulb 60.

The effect of the present invention will be explained as follows.

In the present invention, the magnetic field forming portion for preventing the plasma inside the bulb from being leaked out of the bulb is formed at the peripheral portion of the bulb. As the result, the discharge material such as Na is prevented from being leaked out of the bulb even if the bulb is used for a long time, and thus the lifespan of the bulb is prolonged.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for preventing leakage of a material inside a bulb for a plasma lighting system, comprising:
a bulb containing a discharge material therein for emitting light as the discharge material becomes a plasma state by an electric field; and
a magnetic field forming portion for preventing the discharge material of a plasma state from being leaked by an external electric field of the bulb by forming a magnetic field at a peripheral portion of the bulb.

2. The apparatus of claim 1, wherein the magnetic field forming portion forms a magnetic field as a wedge shape so that the discharge material be positioned at a center of the bulb.

3. The apparatus of claim 1, wherein the discharge material comprises sodium (Na).

4. The apparatus of claim 2, wherein the discharge material comprises Na.

5. An apparatus for preventing leakage of a material inside a bulb for a plasma lighting system, comprising:
a resonator;
a bulb received in the resonator and containing a discharge material therein for emitting light as the discharge material becomes a plasma state by an electric field; and
a magnetic field forming portion for preventing the discharge material of a plasma state from being leaked by an external electric field of the bulb by forming a magnetic field at a peripheral portion of the bulb.

6. The apparatus of claim 5, wherein the magnetic field forming portion forms a magnetic field as a wedge shape so that the discharge material be positioned at a center of the bulb.

7. The apparatus of claim 6, wherein the magnetic field forming portion is implemented as an electromagnet.

8. The apparatus of claim 6, wherein the magnetic field forming portion is implemented as a permanent magnet.

9. The apparatus of claim 5, wherein the discharge material comprises Na.

10. The apparatus of claim 6, wherein the discharge material comprises Na.

11. An apparatus for preventing leakage of a material inside a bulb for a plasma lighting system, comprising:
a casing:
a magnetron mounted in the casing;
a wave guide connected to the magnetron for guiding electromagnetic wave;
a resonator connected to the wave guide for resonating electromagnetic wave;
a bulb received in the resonator and containing a discharge material therein for emitting light as the discharge material becomes a plasma state by an electric field; and
a magnetic field forming portion for preventing the discharge material of a plasma state from being leaked by an external electric field of the bulb by forming a magnetic field at a peripheral portion of the bulb.

12. The apparatus of claim 11, wherein the magnetic field forming portion forms a magnetic field as a wedge shape so that the discharge material be positioned at a center of the bulb.

13. The apparatus of claim 12, wherein the magnetic field forming portion is implemented as an electromagnet.

14. The apparatus of claim 12, wherein a reflector having the resonator therein for forwardly reflecting light generated from the bulb is installed at a front side of the casing.

15. The apparatus of claim 14, wherein the magnetic field forming portion is installed accordingly as the electromagnet is mounted in a housing and the housing is positioned at an outer circumferential surface of the reflector.

16. The apparatus of claim 12, wherein the magnetic field forming portion is installed accordingly as the electromagnet is mounted in a housing and the housing is coupled to the casing.

17. The apparatus of claim 12, wherein the magnetic field forming portion is implemented as a permanent magnet.

18. The apparatus of claim 17, wherein the permanent magnet is attached to an outer circumferential surface of the casing.

19. The apparatus of claim 11, wherein the discharge material comprises Na.

20. The apparatus of claim 12, wherein the discharge material comprises Na.
